(19) United States
(12) Patent Application Publication
(10) Pub. No.: US 2025/0062972 A1
(43) Pub. Date: Feb. 20, 2025

(54) METHOD AND APPARATUS FOR QUALITY OF EXPERIENCE REPORTING CONTINUITY

(71) Applicant: Nokia Technologies Oy, Espoo (FI)

(72) Inventors: Jing HE, Beijing (CN); Ping YUAN, Beijing (CN); Malgorzata TOMALA, Wroclaw (PL)

(21) Appl. No.: 18/721,003

(22) PCT Filed: Jan. 14, 2022
(86) PCT No.: PCT/CN2022/072068

§ 371 Date: Jun. 17, 2024

(51) Int. Cl. H04L 41/5067; H04W 24/10; H04W 28/02

(52) U.S. Cl. CPC H04L 41/5067; H04W 24/10; H04W 28/0278

(57) ABSTRACT

Various example embodiments relate to method and apparatus for quality of experience reporting continuity. A terminal device may be configured to perform Quality of Experience, QoE, measurement on a service received via a source network device, and upon detection of an indication indicative of a mobility procedure for handing over the terminal device from the source network device to a target network device for the service, transmit, during or after the mobility procedure, to the target network device a buffer status report associated with a buffer for storing one or more QoE measurement reports.

### TECHNICAL FIELD

Various example embodiments described herein generally relate to communication technologies, and more particularly, to methods and apparatuses supporting quality of experience (QoE) reporting continuity.

### BACKGROUND

Certain abbreviations that may be found in the description and/or in the figures are herewith defined as follows:
AS Access Stratum
BS Base Station
gNB next Generation Node-B
HO Handover
IMS IP Multimedia Subsystem
MAC Medium Access Control
MBS Multicast Broadcast Service
MTSI Multimedia Telephony Services for IMS
NR New Radio
QMC QoE Measurement Collection
QOE Quality of Experience
RA Random Access
RAN Random Access Network
RRC Radio Resource Control
SRB Signaling Radio Bearer
UE User Equipment
VR Virtual Reality

Mobile communication technology has grown and advanced significantly in the past decade. 5G New Radio (NR), the latest evolution of the cellular communication network, is designed to deliver diverse services and use cases to end users with greater speed, lower latency and massive connectivity. The network operators may quantify end users' satisfaction on the services by collecting quality of experience (QoE) measurements from end user devices.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device is provided. The terminal device may comprise at least one processor and at least one memory including computer program code. The at least one memory and the computer program code may be configured to, with the at least one processor, cause the terminal device at least to perform Quality of Experience, QoE, measurement on a service received via a source network device and, upon detection of an indication indicative of a mobility procedure for handing over the terminal device from the source network device to a target network device for the service, transmit, during or after the mobility procedure, to the target network device a buffer status report associated with a buffer for storing one or more QoE measurement reports.

In a second aspect, an example embodiment of a network device is provided. The network device may comprise at least one processor and at least one memory including computer program code. The at least one memory and the computer program code may be configured to, with the at least one processor, cause the network device at least to receive from a terminal device a buffer status report associated with a buffer for storing one or more Quality of Experience, QoE, measurement reports, during or after a mobility procedure by which the terminal device hands over from a source network device to the network device, and transmit a QoE reporting request message or QoE reporting resume command to the terminal device. The network device may operate as a target network device for the terminal device. The QoE reporting request message or QoE reporting resume command may be determined at least partially based on the received buffer status report.

Example embodiments of methods, apparatus and computer program products are also provided. Such example embodiments generally correspond to the above example embodiments of the terminal and the network device, and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic diagram illustrating a cellular communication network in which example embodiments of the present disclosure can be implemented.

FIG. 2 is a schematic message flow diagram illustrating operations for quality of experience (QoE) measurement reporting in accordance with some example embodiments.

FIG. 3 is a schematic message flow diagram illustrating operations for QoE measurement reporting in accordance with some example embodiments.

FIG. 4 is a schematic message flow diagram illustrating operations for QoE measurement reporting in accordance with some example embodiments.

FIG. 5 is a schematic message flow diagram illustrating operations for QoE measurement reporting in accordance with some example embodiments.

FIG. 6 is a schematic message flow diagram illustrating operations for QoE measurement reporting in accordance with some example embodiments.

FIG. 7 is a schematic message flow diagram illustrating operations for QoE measurement reporting in accordance with some example embodiments.

FIG. 8 is a schematic structure block diagram illustrating devices in a communication system in which example embodiments of the present disclosure can be implemented.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB or an ng-eNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal, a mobile station, a subscriber station, a portable subscriber station, an access terminal, a computer, a wearable device, an on-vehicle communication device, a machine type communication (MTC) device, a D2D communication device, a V2X communication device, a sensor and the like. The term “terminal device” can be used interchangeably with UE, a user terminal, a mobile terminal, a mobile station, or a wireless device.

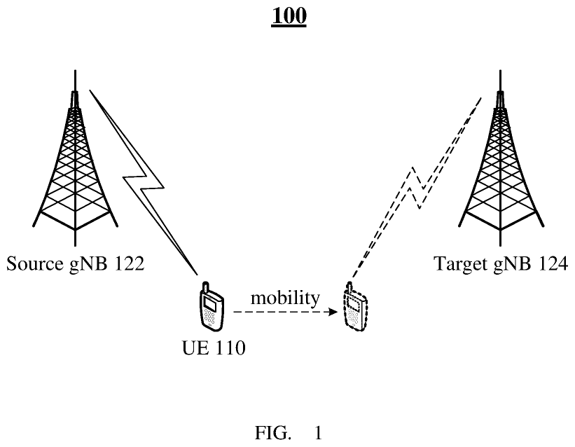

FIG. 1 illustrates a schematic diagram of a cellular communication network 100 in which example embodiments of the present disclosure can be implemented. The cellular communication network 100 may be implemented as a multiple access system capable of supporting communication with multiple users sharing available system resources. The cellular communication network 100 may employ one or more channel access schemes such as Time Division Multiple Access (TDMA), Code Division Multiple Access (CDMA), Time Division Synchronous Code Division Multiple Access (TD-SCDMA), Frequency Division Multiple Access (FDMA), Orthogonal Frequency Division Multiple Access (OFDMA), Single Carrier Frequency Division Multiple Access (SC-FDMA) and the like. These multiple access schemes may be formulated in 4G Long Term Evolution (LTE), 5G New Radio (NR), or beyond 5G radio standards. For convenience of description, FIG. 1 shows the cellular communication network 100 as a 5G NR network including a plurality of 5G base stations “gNB”, but it would be appreciated that example embodiments disclosed herein can also be implemented in a 4G LTE network or a beyond 5G network.

The cellular communication network 100 may include a plurality of base stations (BSs) and a plurality of user equipments (UEs) in wireless communication with the base stations. The plurality of base stations may form a so-called random access network (RAN) and provide network access to the plurality of UEs. The base stations may also connect to a core network (not shown) such as a 5G core network (5GC) via backhaul connections. Each of the base stations may provide service coverage for one or more cells, including for example macro cells and small cells such as femto cells, pico cells and micro cells. A UE may camp in a cell and connect with a base station serving the cell to transmit and receive data on uplink and downlink channels. FIG. 1 depicts two 5G base stations 122, 124 (also referred to as “gNB”) and one UE 110 as an example, and it would be appreciated that the cellular communication network 100 may include any number of base stations providing services for any number of UEs.

In the scenario shown in FIG. 1, it may be assumed that the UE 110 may initially connect to the first base station 122 and receive a service for example a streaming video service through the first base station 122. The UE 110 may also be configured to perform Quality of Experience (QoE) measurements on the service and transmit QoE measurement reports to the network. Different from conventional channel quality measurement that is performed at the physical layer, QoE measurement is performed at the application layer and it aims to quantify how much the end users are satisfied with a service provided by a network operator or a service provider. The network operator or the service provider may configure QoE measurements based on services, applications and/or use cases provided to the end users.

However, frequent transmission of the QoE measurement reports may consume lots of radio resources and cause impact on services for the UE 110 and also on services for other UEs in the cell, especially when for example the base station 122 is in an overload situation. To reduce resource consumption and mitigate the overload, the base station 122 may temporarily pause QoE reporting from the UE 110. Then the UE 110 may store the QoE measurement reports in a local memory. The UE 110 would not transmit the QoE measurement reports until the base station 122 resumes the QoE reporting from the UE 110.

On the other hand, the UE 110 may move for example from the serving cell supported by the first base station 122 to a neighbor cell supported by the second base station 124. When the radio link between the UE 110 and the first base station 122 deteriorate below a threshold due to the increased distance therebetween, the UE 110 may transition from the first base station 122 to the second base station 124 to continue to receive the service for example the streaming video service through the second base station 124. Herein the first base station 122 may be referred to as a source base station, and the second base station 124 may be referred to as a target base station. When the UE 110 moves its connection from the source base station 122 to the target base station 124, an issue is how to ensure QoE measurement collection (QMC) and reporting continuity.

Hereinafter, various example embodiments of methods and apparatuses supporting QMC reporting continuity will be described in detail with reference to the accompanying drawings. In the example embodiments, when a UE detects an indication of a UE mobility procedure, the UE may inform the target base station of how much QoE measurement data is stored at the UE during or after the mobility procedure. Then the target base station can determine when to resume the QoE reporting from the UE at least partially based on the data volume stored at the UE and/or load at the target base station. In the example embodiments, QoE measurement collection and reporting continuity can be ensured after the UE mobility procedure while signaling overhead is not significantly increased.

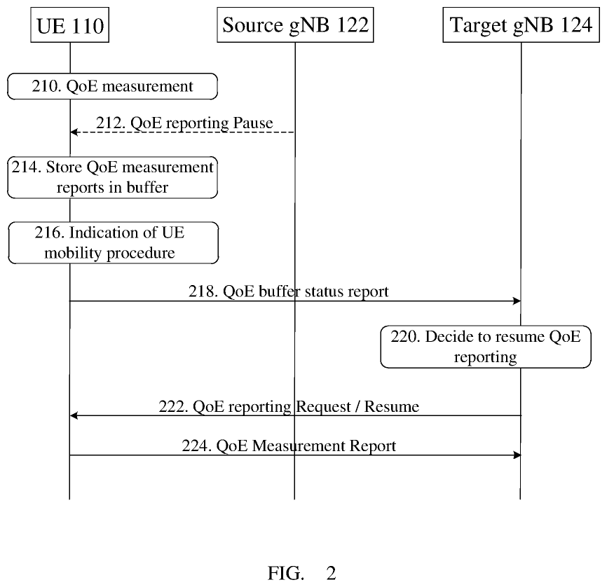

FIG. 2 is a schematic message flow diagram illustrating operations for QoE measurement reporting in accordance with some example embodiments. The operations can be performed by a UE, a source base station and a target base station such as the UE 110, the source base station 122 and the target base station 124 described above with reference to FIG. 1. In some example embodiments, the UE 110, the source base station 122 and the target base station 124 each may include a plurality of means, modules or elements implemented to perform operations discussed below with respect to FIG. 2. The means, modules and elements may be implemented in various manners including but not limited to for example software, hardware, firmware or any combination thereof to perform the operations.

At the beginning of the procedure shown in FIG. 2, it is assumed that the UE 110 is connected to the source base station 122 and receives a service through the source base station 122. Examples of the service may include but not be limited to a streaming video service, an interactive multimedia service like videoconference, a Voice on Internet Protocol (VOIP) service, an Internet Protocol Television (IPTV) service, a Multicast Broadcast service (MBS), a Multimedia Telephony Service for IMS (MTSI), a Virtual Reality (VR) service and the like.

At an operation 210, the UE 110 may perform QoE measurements on the service received through the source base station 122 and generate a QoE measurement report. The QoE measurement may be performed in UE application layer based on QoE configuration received from the network. The core network or Operation and Maintenance (Q&M) may determine QoE configuration for a service or application received at the UE 110 and transmit the QoE configuration via the base station 122 to the UE 110. The QoE configuration may provision QoE metrics and QoE reporting parameters for the UE 110.

At an operation 212, the UE 110 may receive a QoE reporting Pause command from the source base station 122. The QoE reporting Pause command indicates the UE 110 to pause transmission of the QoE measurement report to the base station 122. For example, when the serving cell for the UE 110 is in an overload status, the base station 122 may pause the QoE reporting from the UE 110 to reduce consumption of radio resources.

When the QoE reporting is paused by the network, the UE 110 would not send the QoE measurement report to the network unless a QoE reporting Resume command is received. However, the UE 110 may continue to receive the service and perform QoE measurements on the received service. Then the UE 110 may store one or more QoE measurement reports in a buffer at an operation 214. The buffer may be predefined in the UE application layer or in the UE Access Stratum (AS) layer for storing the QoE measurement reports. It may have a predetermined size such as 32 kB, 64 KB, 128 kB or a larger size. In some example embodiments, the buffer may also be referred to as a QoE buffer, QoE reporting buffer, or a QMC buffer.

In some example embodiments, the UE 110 may also store one or more QoE measurement reports in the QoE buffer when the timing for QoE reporting is not triggered. For example, the network may configure a long period (i.e., a low frequency) for QoE reporting from the UE 110 to reduce resource consumption and impact on other services. The UE 110 may generate one or more QoE measurement reports during the period and temporarily store them in the QoE buffer. For another example, the network may configure a UE load threshold or a cell load threshold for the UE 110. When the threshold is violated, for example when the UE or the cell has higher load than the threshold, the UE 110 would not transmit the QoE measurement reports and instead store the reports in the QoE buffer. In such example embodiments, the operation 212 may be omitted.

At an operation 216, the UE 110 may detect an indication of a UE mobility procedure. The UE mobility procedure refers to a process where the UE 110 transfers its connection from a source base station (e.g. the base station 122) to a target base station (e.g. the base station 124). For example, when the UE 110 moves from the current serving cell in proximity to the source base station 122 to a cell in proximity to the target base station 124 and channel quality between the UE 110 and the target base station 124 becomes better than the channel quality between the UE 110 and the source base station 122, the UE 110 may perform the mobility procedure to transfer connection from the source base station 122 to the target base station 124. Depending on the radio resource control (RRC) connection state of the UE 110, the mobility procedure may be performed in different ways. For example, the mobility procedure may include a handover procedure for handing over a UE in a connected state (RRC_CONNECTED) to another cell by sending the corresponding RRC message, e.g., RRCReconfiguration containing Reconfiguration WithSync or MobilityFromNRCommand, a connection setup procedure for a UE in an idle state (RRC_IDLE), or a connection resume procedure for a UE in an inactive state (RRC_INACTIVE), which will be discussed in detail below. Accordingly, the UE 110 may detect different indications for the mobility procedures. For example, if the UE 110 receives a handover command, it may determine that an indication of the mobility procedure (i.e. the handover procedure) is detected. The indication of the mobility procedure may also be detected from channel quality measurements when the UE 110 is in the inactive or idle state. For example, when a channel quality measurement reveals that channel quality of the serving cell for the UE 110 deteriorates below a predetermined threshold and a neighbor cell becomes the best cell for the UE 110, the UE 110 knows that the channel quality measurement would trigger a UE mobility procedure, i.e. the connection setup procedure for a UE in the idle state or the connection resume procedure for a UE in the inactive state. Then the UE 110 determines that an indication of the mobility procedure is detected from the channel quality measurement. The UE 110 may also detect the indication of the mobility procedure from other messages, signaling, and actions which explicitly or implicitly indicate that a UE mobility procedure would be performed. For example, the messages, signaling and actions utilized in the UE mobility procedure may also be considered as an indication of the mobility procedure.

In response to the indication of the UE mobility procedure, the UE 110 may transmit a QoE buffer status report relating to the buffer for storing the QoE measurement reports to the target base station 124 during or after the mobility procedure at an operation 218. In other words, the QoE buffer status report is triggered by the indication of the mobility procedure. In some example embodiments, the QoE buffer status report may include at least one of size of buffered QoE data (i.e., one or more QoE measurement reports) in the buffer, left space in the buffer, left time before overflow of the buffer, and initial time for the buffer to store the QoE measurement reports. The left time before overflow of the buffer may be calculated from the left space in the buffer, the size of a single QoE measurement report and the frequency of generating the QoE measurement reports. After the left time, the buffer cannot store a new QoE measurement report because of its limited size, and buffer overflow and data loss may occur. The initial time for the buffer to store the QoE measurement reports may refer to the time of receiving the QoE reporting Pause command at the UE 110 or the time of storing the first QoE measurement report in the buffer. The left time before overflow can also be calculated from the initial time to store the QoE measurement reports, the frequency of generating the QoE measurement reports and the total size of the buffer. The QoE buffer status report may be carried in a message transmitted during the mobility procedure, which will be discussed in detail below. In some other example embodiment, the QoE buffer status report may also be transmitted after the mobility procedure, i.e. when the UE 110 has transferred its connection to the target base station 124. From the QoE buffer status report received at the operation 218, the target base station 124 would know how much QoE data needs to be transmitted from the UE 110 to the target base station 124 and/or how long time the buffer can provide storage for new QoE measurement reports.

At an operation 220, the target base station 124 may decide to resume the QoE reporting from the UE 110. In some example embodiments, the target base station 124 may make the decision at least partially based on the QoE buffer status report received from the UE 110 at the operation 218. For example, the target base station 124 has to resume the QoE reporting from the UE 110 before the buffer overflows. The target base station 124 may also make the decision in further consideration of for example load at the new serving cell (the target cell) for the UE 110.

Then at an operation 222, the target base station 124 may send a QoE reporting Request message or a QoE reporting Resume command to the UE 110, which indicates the UE 110 to resume transmitting the QoE measurement reports stored in the QoE buffer to the target base station 124. The QoE reporting Request message or Resume command may be transmitted via RRC signaling, MAC CE or downlink control information (DCI).

In response to the QoE reporting Request message or Resume command, the UE 110 may transmit the QoE measurement reports stored in the QoE buffer to the target base station 124 at an operation 224. When a new QoE measurement report is generated at the UE 110, the UE 110 may also transmit the new report to the target base station 124. The buffered and new QoE measurement reports may be transmitted in a container in an RRC measurement report message. In some example embodiments, the RRC measurement report message may be transmitted on Signaling Radio Bearer Type 4 (SRB4). The container may be transparent to the target base station 124, and the target base station 124 may just forward the container to the core network (not shown). Thus, QoE measurement collection and reporting continuity can be ensured after the UE 110 transfers from the source base station 122 to the target base station 124.

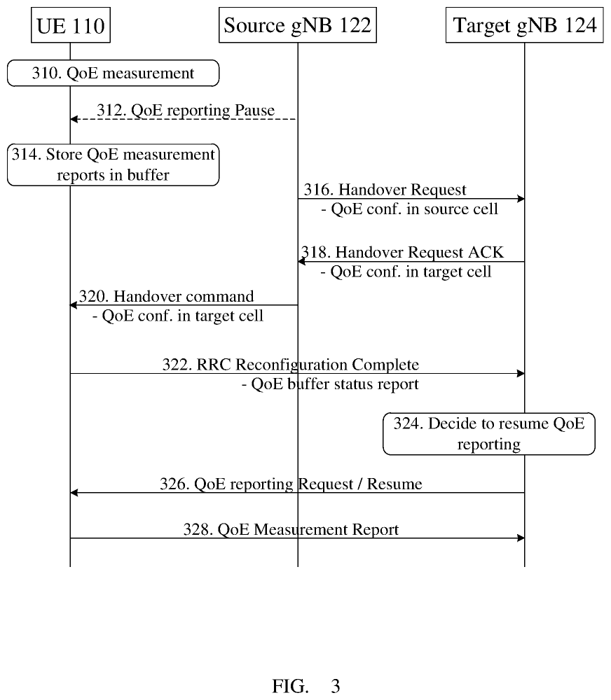

As discussed above, the general procedure shown in FIG. 2 can be implemented in combination with different UE mobility procedures, examples of which will be described below in detail with reference to FIGS. 3-7.

FIG. 3 is a schematic message flow diagram illustrating operations for QoE measurement reporting in accordance with some example embodiments. In the procedure shown in FIG. 3, QoE measurement collection and reporting continuity is achieved when the UE 110 transfers its connection from the source base station 122 to the target base station 124 in a handover procedure.

Referring to FIG. 3, the UE 110 may initially connect to the source base station 122 and perform QoE measurements on a service received through the source base station 122 in an operation 310. When a QoE reporting Pause command is received from the source base station 122 in an operation 312, the UE 110 may stop transmitting the QoE measurement reports to the source base station 122 and instead store the QoE measurement reports in a buffer predefined for QoE measurement report storage at an operation 314. Alternatively or additionally, the UE 110 may also store QoE measurement reports in the QoE buffer when the timing for transmitting the QoE measurement reports is not triggered. The operations 310, 312 and 314 may be similar to the operations 210, 212 and 214 discussed above with respect to FIG. 2, and a repetitive description thereof is omitted here.

At an operation 316, the source base station 122 may send a handover request to the target base station 124. For example, the source base station 122 may make a handover decision based on a channel quality measurement report received from the UE 110. The channel quality measurement report may include channel quality of the serving cell and one or more best cells for the UE 110. When the channel quality of the serving cell deteriorates below a threshold and a neighbor cell supported by the target base station 124 becomes the best quality cell for the UE 110, the source base station 122 may decide to hand over the UE 110 from the current serving cell (the source cell) to the neighbor cell (the target cell) of the target base station 124 and send the handover request to the target base station 124 to initiate the handover procedure. In the example embodiment, the handover request may contain UE context and QoE configuration for the UE 110 in the source cell (i.e. the current serving cell). The QoE configuration of the UE 110 is configured by the source base station 122 before the handover procedure.

If the target base station 124 successfully configures required resources for the UE 110 according to the UE context received in the handover request, the target base station 124 may send a handover request acknowledgement message to the source base station 122 at an operation 318. The handover request acknowledgement message may include a transparent container to be sent to the UE 110 as an RRC message to perform the handover, and the container may include resource allocation information for the UE 110 to access the target cell. In the example embodiment, the container also includes QoE configuration for the UE 110 in the target cell. The target base station 124 may determine the QoE configuration for the UE 110 in the target cell at least partially based on the QoE configuration for the UE 110 in the source cell received in the operation 316. In some example embodiments, the QoE configuration determined at the target base station 124 for the UE 110 in the target cell may also be referred to as new QoE configuration, and the QoE configuration determined at the source base station 122 for the UE 110 in the source cell may also be referred to as old QoE configuration.

At an operation 320, the source base station 122 may send the RRC message prepared by the target base station 124, i.e. an RRC Connection Reconfiguration message, to the UE 110 in a handover command by which the UE 110 is commanded to perform handover. As discussed above with respect to the operation 318, the handover command may include the resource allocation information for the UE 110 to access the target cell and the QoE configuration determined at the target base station 124 for the UE 110 in the target cell. Once the UE 110 receives the handover command, it knows that the handover procedure will be performed and it will trigger transmission of a QoE buffer status report during or after the handover procedure, as discussed above with respect to the operation 216 in FIG. 2.

Based on the handover command, the UE 110 may move connection from the source base station 122 to the target base station 124. The UE 110 may also apply the new QoE configuration to perform QoE measurements on the service received through the target base station 124. At an operation 322, the UE 110 may send an RRC Reconfiguration Complete message to the target base station 124. The RRC Reconfiguration Complete message may include a QoE buffer status report relating to the buffer for storing the QoE measurement reports. As discussed above with respect to the operation 218 in FIG. 2, the QoE buffer status report may include at least one of size of buffered data (i.e., one or more QoE measurement reports) in the buffer, left space in the buffer, left time before overflow of the buffer, and initial time for the buffer to store the QoE measurement reports. From the QoE buffer status report, the target base station 124 can know how much QoE data needs to be transmitted from the UE 110 to the target base station 124 and/or how long time the buffer can provide storage for new QoE measurement reports before buffer overflow occurs.

At an operation 324, the target base station 124 may decide to resume the QoE reporting from the UE 110 at least partially based on the QoE buffer status report received from the UE 110. Then at an operation 326, the target base station 124 may send a QoE reporting Request message or a QoE reporting Resume command to the UE 110, which indicates the UE 110 to resume transmitting the QoE measurement reports stored in the buffer to the target base station 124. In response to the QoE reporting Request message or Resume command, the UE 110 may transmit on SRB4 the QoE measurement reports stored in the buffer to the target base station 124 at an operation 328. The operations 324, 326 and 328 may be similar to the operations 220, 222 and 224 discussed above with respect to FIG. 2, and a repetitive description thereof is omitted here.

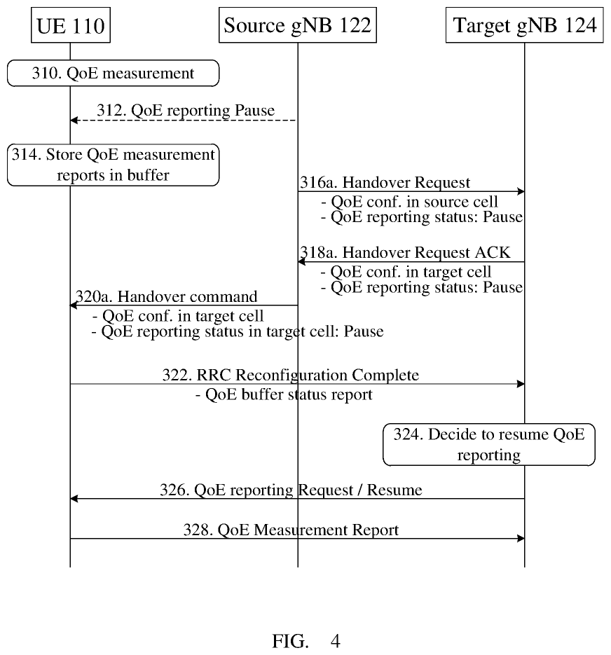

In the procedure shown in FIG. 3, the target base station 124 does not know if the QoE reporting is paused or not when the UE 110 connects to the source base station 122. When the QoE buffer status report is received from the UE 110, the target base station 124 may determine the timing to resume the QoE reporting from the UE 110. In some other example embodiments, the source base station 122 may also inform the target base station 124 of the QoE reporting status in the UE 110. FIG. 4 illustrates such an example. In the procedure shown in FIG. 4, operations similar to those shown in FIG. 3 are denoted with similar reference numerals and a repetitive description thereof is omitted here.

Referring to FIG. 4, at an operation 316a, the handover request transmitted from the source base station 122 to the target base station 124 may further include a QoE reporting status indication for the UE 110 in the source cell, in addition to the old QoE configuration for the UE 110 in the source cell. The QoE reporting status indication may indicate whether or not the QoE reporting from the UE 110 is paused by the source base station 122. In the example embodiment shown in FIG. 4, the QoE reporting status indication indicates that the QoE reporting from the UE 110 is paused by the source base station 122.

At an operation 318a, the handover request acknowledgement message transmitted from the target base station 124 to the source base station 122 may further include a new QoE reporting status indication for the UE 110 in the target cell, in addition to the new QoE configuration for the UE 110 in the target cell. The new QoE reporting status indication for the UE 110 in the target cell may be determined by the target base station 124 based on for example the old QoE reporting status of the UE 110 before the handover procedure and the load of the target cell. For example, if the QoE reporting from the UE 110 to the source base station 122 is paused before the handover procedure and/or the target cell is in an overload situation, the target base station 124 may pause QoE reporting from the UE 110 to the target base station 124. FIG. 4 shows an example where the target base station 124 also pauses the QoE reporting from the UE 110 in the new QoE reporting status indication.

Then the source base station 122 may forward the new QoE reporting status indication together with the new QoE configuration to the UE 110 in the handover command at an operation 320a. Since the QoE reporting is paused by the target base station 124, the UE 110 would not transmit the QoE measurement reports stored in the buffer to the target base station 124 until it receives the QoE reporting request message or the QoE reporting resume command in the operation 326.

In some example embodiments, the target base station 124 may decide to resume the QoE reporting from the UE 110 at the operation 318a, when for example the target cell has low load. When the UE 110 receives the QoE reporting status indication to resume the QoE reporting at the operation 320a, the UE 110 may transmit the QoE buffer status report to the target base station 124 at the operation 322 and transmit the QoE measurement reports to the target base station 124 at the operation 328. The operations 324, 326 may be omitted in this example embodiment.

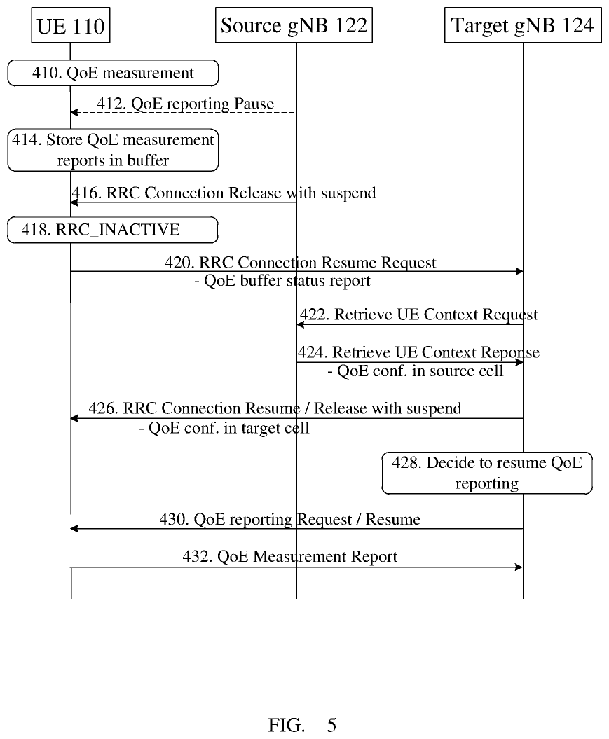

FIG. 5 is a schematic message flow diagram illustrating operations for QoE measurement reporting in accordance with some example embodiments. In the procedure shown in FIG. 5, QoE measurement collection and reporting continuity is achieved when the UE 110 performs a connection resume procedure to recover from the RRC inactive state to the RRC connected state.

Referring to FIG. 5, the UE 110 may initially connect to the source base station 122 and perform QoE measurements on a service received through the source base station 122 in an operation 410. When a QoE reporting Pause command is received from the source base station 122 in an operation 412, the UE 110 may stop transmitting the QoE measurement reports to the source base station 122 and instead store the QoE measurement reports in a buffer predefined for QoE measurement report storage at an operation 414. Alternatively or additionally, the UE 110 may also store QoE measurement reports in the buffer when the timing for transmitting the QoE measurement reports is not triggered. The operations 410, 412 and 414 may be similar to the operations 210, 212 and 214 discussed above with respect to FIG. 2, and a repetitive description thereof is omitted here.

At an operation 416, the source base station 122 may send an RRC Connection Release with suspend message to the UE 110 to put the UE 110 in the RRC inactive state. In response to the RRC message, the UE 110 transitions from the RRC connected state to the RRC inactive state at an operation 418. In some example embodiments, the UE 110 can still receive the service e.g. streaming video service, the Multicast Broadcast Service (MBS), the Multimedia Telephony Service for IMS (MTSI), or the Virtual Reality (VR) service from the source base station 122 and perform the QoE measurements on the service when it is in the inactive state.

At an operation 420, the UE 110 may send an RRC Connection Resume Request message to the target base station 124 to initiate a UE mobility procedure. In some example embodiments, the network may initiate the UE mobility procedure by paging the UE 110, and then the UE 110 may send the RRC Connection Resume Request message to the target base station 124. As discussed above, the UE 110 may detect/determine an indication of the mobility procedure from the channel quality measurement revealing that the channel quality of the last serving cell for the UE 110 deteriorates below a predetermined threshold and a neighbor cell supported by the target base station 124 becomes the best cell for the UE 110. In the example embodiment, the RRC Connection Resume Request message may include a QoE buffer status report relating to the buffer for storing the QoE measurement reports at the UE 110. As discussed above with respect to the operation 218 in FIG. 2, the buffer status report may include at least one of size of buffered data (i.e., one or more QoE measurement reports) in the buffer, left space in the buffer, left time before overflow of the buffer, and initial time for the buffer to store the QoE measurement reports. From the buffer status report, the target base station 124 can know how much QoE data needs to be transmitted from the UE 110 to the target base station 124 and/or how long time the buffer can provide storage for new QoE measurement reports before buffer overflow occurs.

At an operation 422, the target base station 124 may request the source base station 122 to provide UE context of the UE 110 by sending a Retrieve UE Context Request message to the source base station 122.

At an operation 424, the source base station 122 may transmit UE Context of the UE 110 to the target base station 124 via a Retrieve UE Context response message. The Retrieve UE Context response message may include QoE configuration for the UE 110 in the source cell. In some example embodiments, the Retrieve UE Context response message may further include a QoE reporting status indication for the UE 110 in the source cell. The QoE reporting status indication may indicate that the QoE reporting from the UE 110 is paused by the source base station 122.

The target base station 124 may move the UE 110 to the RRC connected state by sending an RRC Connection Resume message to the UE 110 at an operation 426. Alternatively, the target base station 124 may send the UE 110 back to the RRC inactive state by sending an RRC Release with suspend message. In either case, the RRC Connection Resume message or the RRC Release with suspend message may include a new QoE configuration for the UE 110 in the target cell. In some example embodiments, the RRC Connection Resume message or the RRC Release with suspend message may further include a new QoE reporting status indication for the UE 110 in the target cell. The target base station 124 may determine the new QoE reporting status indication for the UE 110 based on for example the old QoE reporting status of the UE 110 in the source cell and the load in the target cell. In the example shown in FIG. 4, the target base station 124 may also decide to pause the QoE reporting from the UE 110 in the new QoE reporting status indication.

At an operation 428, the target base station 124 may decide to resume the QoE reporting from the UE 110 at least partially based on the buffer status report received from the UE 110. Then at an operation 430, the target base station 124 may send a QoE reporting Request message or a QoE reporting Resume command to the UE 110, which indicates the UE 110 to resume transmitting the QoE measurement reports stored in the buffer to the target base station 124. In response to the QoE reporting Request message or Resume command, the UE 110 may transmit on SRB4 the QoE measurement reports stored in the buffer to the target base station 124 at an operation 432. The operations 4284, 430 and 432 may be similar to the operations 220, 222 and 224 discussed above with respect to FIG. 2, and a repetitive description thereof is omitted here.

In some example embodiments, the target base station 124 may decide to resume the QoE reporting from the UE 110 at the operation 426 for example when the target cell has low load. When the UE 110 receives the QoE reporting status indication to resume the QoE reporting, the UE 110 may transmit the QoE measurement reports to the target base station 124 at the operation 432. The operations 428, 430 may be omitted in this example embodiment.

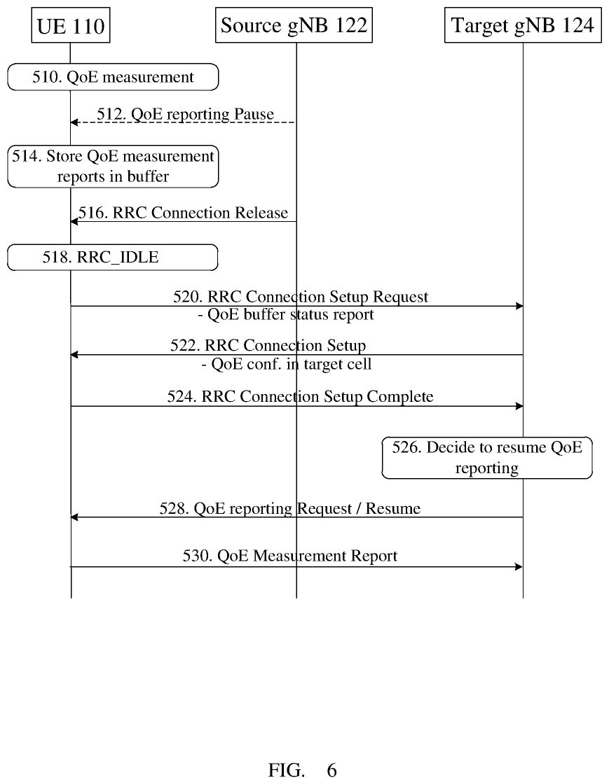

FIG. 6 is a schematic message flow diagram illustrating operations for QoE measurement reporting in accordance with some example embodiments. In the procedure shown in FIG. 6, QoE measurement collection and reporting continuity is achieved when the UE 110 is in the idle state and it performs a connection setup procedure to establish RRC connection with the target base station.

Referring to FIG. 6, the UE 110 may initially connect to the source base station 122 and perform QoE measurements on a service received through the source base station 122 in an operation 510. When a QoE reporting Pause command is received from the source base station 122 in an operation 512, the UE 110 may stop transmitting the QoE measurement reports to the source base station 122 and instead store the QoE measurement reports in a buffer predefined for QoE measurement report storage at an operation 514. Alternatively or additionally, the UE 110 may also store QoE measurement reports in the buffer when the timing for transmitting the QoE measurement reports is not triggered. The operations 510, 512 and 514 may be similar to the operations 210, 212 and 214 discussed above with respect to FIG. 2, and a repetitive description thereof is omitted here.

At an operation 516, the source base station 122 may send an RRC Connection Release message to the UE 110 to put the UE 110 in the RRC idle state. In response to the RRC message, the UE 110 transitions from the RRC connected state to the RRC idle state at an operation 518. When the UE 110 is in the idle state, it may stop receiving the service from the source base station 122, but the QoE measurement reports stored in the QoE buffer may be kept at the UE 110.

When the UE 110 detects from a channel quality measurement that the channel quality of the last serving cell for the UE 110 deteriorates below a predetermined threshold and a neighbor cell supported by the target base station 124 becomes the best cell for the UE 110, the UE 110 may establish connection with the target base station 124 in a connection setup procedure. At an operation 520, the UE 110 may send an RRC Connection Setup Request message to the target base station 124. The RRC Connection Setup Request may be transmitted via Msg. 3 in a 4-step random access (RA) procedure or via Msg. A in a 2-step RA procedure. In the example embodiments, the RRC Connection Setup Request message may include a QoE buffer status report relating to the buffer for storing the QoE measurement reports at the UE 110. As discussed above with respect to the operation 218 in FIG. 2, the buffer status report may include at least one of size of buffered data (i.e., one or more QoE measurement reports) in the buffer, left space in the buffer, left time before overflow of the buffer, and initial time for the buffer to store the QoE measurement reports. From the buffer status report, the target base station 124 can know how much QoE data needs to be transmitted from the UE 110 to the target base station 124 and/or how long time the buffer can provide storage for new QoE measurement reports before buffer overflow occurs.

In some example embodiments, the RRC Connection Setup Request transmitted at the operation 520 may further include a QoE reporting status indication for the UE 110 when the UE 110 connects to the source base station 122. The QoE reporting status indication may indicate that the QoE reporting from the UE 110 is paused by the source base station 122.

At an operation 522, the target base station 124 may send an RRC Connection Setup message to the UE 110. The RRC Connection Setup message may be transmitted via Msg. 4 in the 4-step RA procedure or via Msg. B in the 2-step RA procedure. In the example embodiments, the RRC Connection Setup message may include QoE configuration for the UE 110 in the target cell.

In some example embodiments, the RRC Connection Setup message may further include a new QoE reporting status indication for the UE 110 in the target cell. The target base station 124 may determine the new QoE reporting status indication for the UE 110 based on for example the old QoE reporting status of the UE 110 before the connection setup procedure and the load in the target cell. In the example shown in FIG. 6, the target base station 124 may also decide to pauses the QoE reporting from the UE 110 in the new QoE reporting status indication.

At an operation 524, the UE 110 may send an RRC Connection Setup Complete message to the target base station 124.

At an operation 526, the target base station 124 may decide to resume the QoE reporting from the UE 110 at least partially based on the buffer status report received from the UE 110. Then at an operation 528, the target base station 124 may send a QoE reporting Request message or a QoE reporting Resume command to the UE 110, which indicates the UE 110 to resume transmitting the QoE measurement reports stored in the buffer to the target base station 124. In response to the QoE reporting Request message or Resume command, the UE 110 may transmit on SRB4 the QoE measurement reports stored in the buffer to the target base station 124 at an operation 530. The operations 526, 528 and 530 may be similar to the operations 220, 222 and 224 discussed above with respect to FIG. 2, and a repetitive description thereof is omitted here.

In some example embodiments, the target base station 124 may decide to resume the QoE reporting from the UE 110 at the operation 522 for example when the target cell has low load. When the UE 110 receives the QoE reporting status indication to resume the QoE reporting, the UE 110 may transmit the QoE measurement reports to the target base station 124 at the operation 530. The operations 526, 528 may be omitted in this example embodiment.

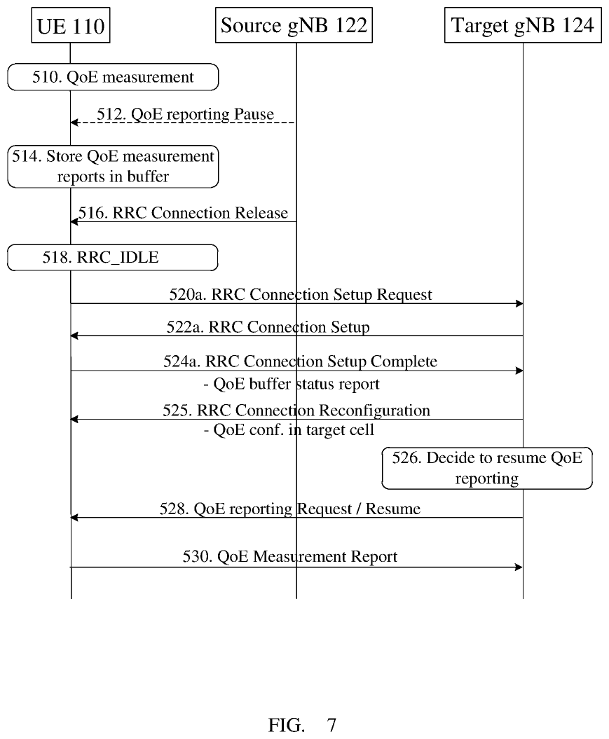

FIG. 7 illustrates another example of operations to ensure QoE measurement collection and reporting continuity when the UE 110 performs a connection setup procedure. In the procedure shown in FIG. 7, operations similar to those shown in FIG. 6 are denoted with similar reference numerals and a repetitive description thereof is omitted here.

Referring to FIG. 7, the UE 110 may send to the target base station 124 the QoE buffer status report in the RRC Connection Setup Complete message transmitted in the operation 524a, instead of in the RRC Connection Setup Request message transmitted in the operation 520a. In addition, the target base station 124 may send to the UE 110 the QoE configuration for the UE 110 in the target cell in an RRC Connection Reconfiguration message transmitted in an operation 525, instead of in the RRC Connection Setup message transmitted in the operation 522a. In some example embodiments, the target base station 124 may send the QoE configuration to the UE 110 in the operation 522a, and the operation 525 may be omitted. Other aspects of the procedure shown in FIG. 7 may be similar to the procedure shown in FIG. 6 and a repetitive description is omitted here.

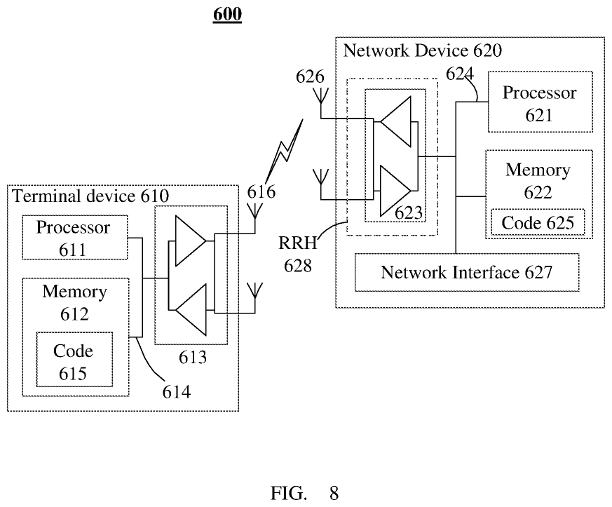

FIG. 8 is a schematic block diagram illustrating devices in a communication system 600 for implementing one or more example embodiments. As shown in FIG. 8, the communication system 600 may comprise a plurality erminal devices 610 (one is shown) which may be implemented as the UE 110 discussed above and a plurality of network devices 620 (one is shown) which may be implemented as the base stations 122, 124 discussed above.

Referring to FIG. 8, the terminal device 610 may comprise one or more processors 611, one or more memories 612 and one or more transceivers 613 interconnected through one or more buses 614. The one or more buses 614 may be address, data, or control buses, and may include any interconnection mechanism such as series of lines on a motherboard or integrated circuit, fiber, optics or other optical communication equipment, and the like. Each of the one or more transceivers 613 may comprise a receiver and a transmitter, which are connected to one or more antennas 616. The terminal device 610 may wirelessly communicate with the network device 620 through the one or more antennas 616. The one or more memories 612 may include computer program code 615. The one or more memories 612 and the computer program code 615 may be configured to, when executed by the one or more processors 611, cause the terminal device 610 to perform processes and steps relating to the UE 110 as described above.

The network device 620 may comprise one or more processors 621, one or more memories 622, one or more transceivers 623 and one or more network interfaces 627 interconnected through one or more buses 624. The one or more buses 624 may be address, data, or control buses, and may include any interconnection mechanism such as a series of lines on a motherboard or integrated circuit, fiber, optics or other optical communication equipment, and the like. Each of the one or more transceivers 623 may comprise a receiver and a transmitter, which are connected to one or more antennas 626. The network device 620 may wirelessly communicate with the terminal device 610 through the one or more antennas 626. The one or more transceivers 623 and the one or more antennas 626 may be implemented as one or more remote radio heads (RRHs) 628. The one or more RRHs 628 may be collocated or located at different positions. The one or more buses 624 could be implemented in part as fiber optic cable to connect the RRHs 628 to other components of the network device 620. The one or more network interfaces 627 may provide wired or wireless communication links through which the network device 620 may communicate with other network devices, entities, elements or functions. The one or more memories 622 may include computer program code 625. The one or more memories 622 and the computer program code 625 may be configured to, when executed by the one or more processors 621, cause the network device 620 to perform processes and steps relating to the base station 120 as described above.

The one or more processors 611, 621 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 611, 621 may be configured to control other elements of the UE/network device and operate in cooperation with them to implement the procedures discussed above.

The one or more memories 612, 622 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 612, 622 may include but not limited to an electric, a magnetic, an optical, an electromagnetic, an infrared, or a semiconductor system, apparatus, or device or any combination of the above.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Some exemplary embodiments further provide computer program code or instructions which, when executed by one or more processors, may cause a device or apparatus to perform the procedures described above. The computer program code for carrying out procedures of the exemplary embodiments may be written in any combination of one or more programming languages. The computer program code may be provided to one or more processors or controllers of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

Some exemplary embodiments further provide a computer program product or a computer readable medium having the computer program code or instructions stored therein. The computer readable medium may be any tangible medium that may contain, or store a program for use by or in connection with an instruction execution system, apparatus, or device. The machine readable medium may be a machine readable signal medium or a machine readable storage medium. A machine readable medium may include but is not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

1. A terminal device comprising:
at least one processor; and
at least one memory including computer program code, the at least one memory and the computer program code being configured to, with the at least one processor, cause the terminal device at least to:
perform Quality of Experience, QoE, measurement on a service received via a source network device; and
upon detection of an indication indicative of a mobility procedure for handing over the terminal device from the source network device to a target network device for the service, transmit, during or after the mobility procedure, to the target network device a buffer status report associated with a buffer for storing one or more QoE measurement reports.

2. The terminal device of claim 1 wherein the indication indicative of the mobility procedure is detected from a handover command when the terminal device is in a connected state or from channel quality measurement when the terminal device is in an idle or inactive state.

3. The terminal device of claim 1 wherein the one or more QoE measurement reports are stored in the buffer before timing for transmission of the one or more QoE measurement reports is triggered or when the terminal device receives a QoE reporting pause command from the source network device which indicates the terminal device to pause transmitting the one or more QoE measurement reports to the source network device.

4. The terminal device of claim 1 wherein the buffer status report is transmitted to the target network device via an RRC Reconfiguration Complete message, an RRC Connection Resume Request message, an RRC Connection Setup Request message or an RRC Connection Setup Complete message.

5. The terminal device of claim 1 wherein the buffer status report comprises at least one of:
size of the one or more QoE measurement reports stored in the buffer;
left space in the buffer;
left time before overflow of the buffer; and
initial time for the buffer to store the one or more QoE measurement reports.

6. The terminal device of claim 1 wherein the at least one memory and the computer program code are further configured to, with the at least one processor, cause the terminal device at least to:
receive a QoE configuration for the target network device from the source network device or the target network device.

7. The terminal device of claim 6 wherein the QoE configuration is received via a handover command from the source network device or via an RRC Connection Resume message, an RRC Connection Release with Suspend message, an RRC Connection Reconfiguration message or an RRC Connection Setup message from the target network device.

8. The terminal device of claim 7 wherein the handover command received from the source network device or the RRC Connection Resume message, the RRC Connection Release with Suspend message, the RRC Connection Reconfiguration message or the RRC Connection Setup message received from the target network device further includes a QoE reporting status indication for the terminal device determined at the target network device.

9. The terminal device of claim 1 wherein the at least one memory and the computer program code are further configured to, with the at least one processor, cause the terminal device at least to:
receive, from the target network device, a QoE reporting request message or QoE reporting resume command indicating to the terminal device to resume transmitting the one or more QoE measurement reports stored in the buffer to the target network device; and
transmit the one or more QoE measurement reports stored in the buffer to the target network device, responsive to the received QoE reporting request message or QoE reporting resume command.

10. The terminal device of claim 1 wherein the QoE reporting request message or QoE reporting resume command is received after transmitting the buffer status report to the target network device.

11. A network device comprising:
at least one processor; and
at least one memory including computer program code, the at least one memory and the computer program code being configured to, with the at least one processor, cause the network device at least to:
receive from a terminal device a buffer status report associated with a buffer for storing one or more Quality of Experience, QoE, measurement reports, during or after a mobility procedure by which the terminal device hands over from a source network device to the network device, the network device operating as a target network device for the terminal device; and
transmit a QoE reporting request message or QoE reporting resume command to the terminal device, the QoE reporting request message or QoE reporting resume command being determined at least partially based on the received buffer status report.

12. The network device of claim 11 wherein the buffer status report is received via an RRC Reconfiguration Complete message, an RRC Connection Resume Request message, an RRC Connection Setup Request message or an RRC Connection Setup Complete message.

13. The network device of claim 11 wherein the buffer status report comprises at least one of:
size of the one or more QoE measurement reports stored in the buffer;
left space in the buffer;
left time before overflow of the buffer; and
initial time for the buffer to store the one or more QoE measurement reports.

14. The network device of claim 11 wherein the at least one memory and the computer program code are further configured to, with the at least one processor, cause the network device at least to:
transmit a QoE configuration for the terminal device to the terminal device or via the source network device to the terminal device.

15. The network device of claim 14 wherein the at least one memory and the computer program code are further configured to, with the at least one processor, cause the network device at least to:
receive an old QoE configuration for the terminal device from the source network device, the old QoE configuration being configured by the source network device before the mobility procedure.

16. The network device of claim 15 wherein the QoE configuration is transmitted via a handover request acknowledgement message to the source network device or via an RRC Connection Resume message, an RRC Connection Release with Suspend message, an RRC Connection Reconfiguration message or an RRC Connection Setup message to the terminal device, and
the old QoE configuration for the terminal device is received via a handover request or a retrieve terminal device context response message from the source network device.

17. The network device of claim 16 wherein the handover request received from the source network device further includes a current QoE reporting status indication for the terminal device, and the handover request acknowledgement message transmitted to the source network device further includes a new QoE reporting status indication determined at the target network device,
wherein the current QoE reporting status is indicative of whether transmitting the one or more QoE measurement reports is paused for the terminal device by the source network device and the new QoE reporting status is indicative of whether transmitting the one or more QoE measurement reports is paused for the terminal device by the target network device.

18. A method implemented at a terminal device comprising:
performing Quality of Experience, QoE, measurement on a service received via a source network device; and
upon detection of an indication indicative of a mobility procedure for handing over the terminal device from the source network device to a target network device for the service, transmitting, during or after the mobility procedure, to the target network device a buffer status report associated with a buffer for storing one or more QoE measurement reports.

19. The method of claim 18 wherein the indication indicative of the mobility procedure is detected from a handover command when the terminal device is in a connected state or from channel quality measurement when the terminal device is in an idle or inactive state.

20. The method of claim 18 wherein the one or more QoE measurement reports are stored in the buffer before timing for transmission of the one or more QoE measurement reports is triggered or when the terminal device receives a QoE reporting pause command from the source network device which indicates the terminal device to pause transmitting the one or more QoE measurement reports to the source network device.

21-38. (canceled)
